(19) United States
(12) Patent Application Publication
(10) Pub. No.: US 2024/0340899 A1
(43) Pub. Date: Oct. 10, 2024

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/575,582

(22) PCT Filed: Jul. 2, 2021
(86) PCT No.: PCT/CN2021/104383

§ 371 Date: Dec. 29, 2023

(51) Int. Cl. H04W 72/1273; H04L 1/00; H04L 1/1812; H04W 72/044; H04W 72/0446; H04W 72/232

(52) U.S. Cl. CPC H04W 72/1273; H04L 1/0008; H04L 1/1812; H04W 72/0446; H04W 72/046; H04W 72/232

(57) ABSTRACT

Embodiments of the present disclosure relate to methods, devices and computer readable media for communication. A terminal device receives, from a network device, multiple code block group (CBG)-based transmissions scheduled by a first downlink control information (DCI), and at least one transport block (TB)-based transmission; and transmit, to the network device, a HARQ-acknowledgement (HARQ-ACK) codebook comprising HARQ feedbacks of the multiple CBG-based transmissions and the at least one TB-based transmission. In this way, the HARQ-ACK codebook is adapted to report HARQ feedbacks in a case where CBG-based transmission and multi-transmission scheduling are both configured. As such, the overhead of DCI can be reduced and the transmission efficiency can be improved.

### TECHNICAL FIELD

Embodiments of the present disclosure generally relate to the field of telecommunication, and in particular, to methods, devices and computer storage media of enhancement on HARQ-acknowledgement (HARQ-ACK) codebook.

### BACKGROUND

A downlink control information (DCI) can be used by a network device (e.g., gNodeB) for single Physical Downlink Shared Channel (PDSCH) scheduling at either a transport-block (TB)-level or a code block group (CBG)-level.

With the development of communication technology, it has been proposed to use a single DCI for multi-PDSCH scheduling at the CBG-level and configure such DCI with a Time Domain Resource Allocation (TDRA) table containing at least one row with multiple Start and Length Indication Values (SLIVs). Upon receipt of the multiple transmissions, a terminal device may transmit corresponding HARQ feedbacks in a HARQ-ACK codebook. In view of the changes in scheduling manner, the HARQ-ACK codebook may need to be improved accordingly.

### SUMMARY

In general, embodiments of the present disclosure provide methods, devices and computer storage media for communication during scheduling of multi-TTI in one downlink control channel.

In a first aspect, there is provided a method of communication. The method comprises: receiving, at a terminal device and from a network device, multiple code block group (CBG)-based PDSCH transmissions scheduled by a first downlink control information (DCI), and at least one transport block (TB)-based PDSCH transmission; and transmitting, to the network device, a HARQ-acknowledgement (HARQ-ACK) codebook comprising HARQ feedbacks of the multiple CBG-based PDSCH transmissions and the at least one TB-based PDSCH transmission.

In a second aspect, there is provided a method of communication. The method comprises: transmitting, at a network device and from a terminal device, multiple code block group (CBG)-based PDSCH transmissions scheduled by a first downlink control information (DCI), and at least one transport block (TB)-based PDSCH transmission; and receiving, from the terminal device, a HARQ-acknowledgement (HARQ-ACK) codebook comprising HARQ feedbacks of the multiple CBG-based PDSCH transmissions and the at least one TB-based PDSCH transmission.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented:

FIG. 2 illustrates a schematic diagram illustrating a process for multi-downlink data channel scheduling according to embodiments of the present disclosure:

FIG. 3 illustrates a schematic diagram illustrating an example HARQ-ACK codebook according to embodiments of the present disclosure:

FIG. 4A illustrates a schematic diagram illustrating another example HARQ-ACK codebook according to embodiments of the present disclosure:

FIG. 4B illustrates a schematic diagram illustrating an example size of the HARQ-ACK codebook with three sub-codebooks according to embodiments of the present disclosure:

FIG. 5 illustrates a schematic diagram illustrating still another example HARQ-ACK codebook according to embodiments of the present disclosure:

FIG. 6A illustrates a schematic diagram illustrating an example bundling for HARQ feedbacks of multi-downlink data channel scheduling by a single DCI in time domain according to embodiments of the present disclosure:

FIG. 6B illustrates a schematic diagram illustrating another example bundling for HARQ feedbacks of multi-downlink data channel scheduling by a single DCI in time domain according to embodiments of the present disclosure:

FIG. 6C illustrates a schematic diagram illustrating yet another example bundling for HARQ feedbacks of multi-downlink data channel scheduling by a single DCI in time domain according to embodiments of the present disclosure:

FIG. 7 illustrates a schematic diagram illustrating an example bundling for HARQ feedbacks of multiple CBG-based transmissions scheduled by a single DCI in spatial domain according to embodiments of the present disclosure:

FIG. 8 illustrates another example method of communication implemented at a terminal device in accordance with some embodiments of the present disclosure:

FIG. 9 illustrates another example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and play back appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

A network device can assign a plurality of serving cells for serving a terminal device in a PUCCH cell group, and the number of the serving cells will be denoted by N_{cells}^{DL} in the following. Each of the plurality of serving cells corresponds to a different component carrier (CC) which in turns corresponds to a different PDSCH. Taking CC0, CC1, and CC2 as examples, CC0 is configured for single PDSCH scheduling and TB-based transmission, that is, CC0 may be used for single TB-based transmission scheduled by a single DCI. CC1 is configured for single PDSCH scheduling and CBG-based transmission, that is. CC1 may be used for single CBG-based transmission scheduled by a single DCI. Moreover, CC2 is configured for multi-PDSCH scheduling and TB-based transmission, that is, CC2 may be used for multiple TB-based transmissions scheduled by a single DCI.

When the downlink transmissions are received on a PDSCH, the terminal device needs to feedback at least one HARQ-Acknowledgement/Negative-acknowledgement (ACK/NACK). To this end, the terminal device may generate the HARQ-ACK codebook comprising HARQ feedbacks of the downlink transmissions. The HARQ-ACK codebook may be further divided into sub-codebooks. At most two sub-codebooks can be supported for a Physical Uplink Control Channel (PUCCH) cell group. For example, the first sub-codebook may be generated for any DCI that is not configured with CBG-based transmission scheduling and is configured with a TDRA table containing rows each with a single SLIV, additionally or alternatively, any DCI that is not configured with CBG-based transmission scheduling and is configured with a TDRA table containing at least one row with multiple SLIVs and schedules only a single PDSCH. The second sub-codebook may be generated for any DCI that is configured with a TDRA table containing at least one row with multiple SLIVs and schedules multiple PDSCHs.

However, the design of HARQ codebook as described above may not be adapted to reporting HARQ feedbacks when a single DCI is used for scheduling multiple CBG-based transmissions. Further, a reduced overhead of the HARQ-ACK feedback may be desirable especially when the number of sub-codebooks contained in the HARQ-ACK codebook is getting larger. There are also concerns for how to arrange the HARQ-ACK for Semi-Persistent Scheduling PDSCH (SPS PDSCH), the SPS PDSCH release indication, the SCell dormancy indication and so on in the Type 2 HARQ-ACK codebook, and how to configure the Downlink Assignment index (DAI) in the uplink DCI.

Embodiments of the present disclosure provide solutions for solving the above and other potential issues. Generally, an enhanced HARQ-ACK codebook is provided to report HARQ feedbacks in a case where CBG-based transmission and multi-transmission scheduling are both configured. The number of the sub-codebooks contained in the enhanced HARQ-ACK codebook can be dynamically and flexibly determined based on certain rules. Moreover, it is possible to bundle the HARQ feedbacks per sub-codebook in either the time domain or the spatial domain. As such, the overhead of DCI can be reduced and the transmission efficiency can be improved.

Principles and implementations of the present disclosure will be described in detail below with reference to the figures.

### Example of Communication Network

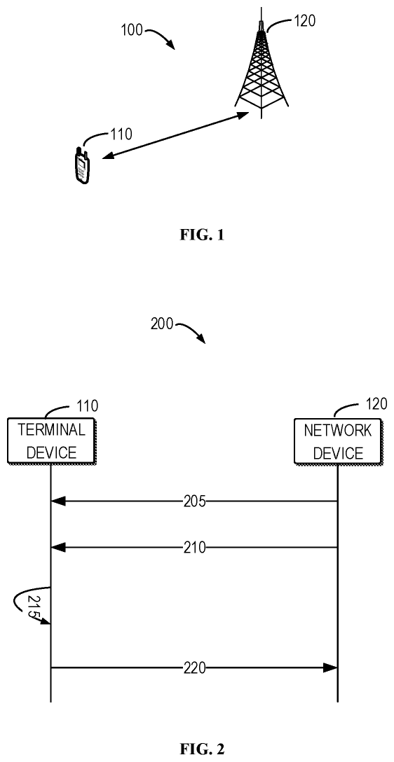

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the terminal device 110 may be served by the network device 120. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The terminal device 110 may transmit uplink data to the network device 120 via an uplink data channel transmission. For example, the uplink data channel transmission may be a PUSCH transmission. Of course, any other suitable forms are also feasible. In some embodiments, the terminal device 110 may receive downlink data from the network device 120 via a downlink data channel transmission. For example, the downlink data channel transmission may be a PDSCH transmission. Of course, any other suitable forms are also feasible.

The terminal device 110 may receive a DCI, e.g., data transmission configuration from the network device 120 via a downlink control channel transmission. For example, the downlink control channel transmission may be a PDCCH transmission. Of course, any other suitable forms are also feasible.

The terminal device 110 may transmit uplink control information (UCI), e.g., HARQ feedback information to the network device 120 via an uplink channel transmission. For example, the uplink channel transmission may be a PUCCH or PUSCH transmission. Of course, any other suitable forms are also feasible.

The network device 120 may provide a plurality of serving cells (not shown herein) for the terminal device 110, for example, a primary cell (PCell), a primary secondary cell (PSCell), a secondary cell (SCell), a special cell (sPCell) or the like. Each of the serving cells may correspond to a CC. The terminal device 110 may perform transmission with the network device 120 via a CC. The terminal device 110 may also perform transmission with the network device 120 via multiple CCs, for example, in case of carrier aggregation (CA).

The network device 120 may schedule downlink data transmissions via different CCs in various manners. For example, the network device 120 may schedule single TB-based transmission by a DCI on a CC that is configured with single-PDSCH scheduling and TB-based transmission. Additionally or alternatively, the network device 120 may schedule single CBG-based transmission by a DCI on a CC that is configured with single-PDSCH scheduling and CBG-based transmission. For a CC that is configured with multi-PDSCH scheduling and TB-based transmission, the network device 120 may schedule multiple TB-based transmissions by a DCI. For a CC that is configured with multi-PDSCH scheduling and CBG-based transmission, the network device 120 may schedule multiple CBG-based transmissions by a DCI.

The terminal device 110 may then generate a HARQ-ACK codebook comprising HARQ feedbacks of the downlink data transmissions. FIG. 2 illustrates a schematic diagram illustrating a process for multi-downlink data channel scheduling according to embodiments of the present disclosure. The process 200 as shown in FIG. 2 involves a situation where at least one of the CCs for the terminal device 110 is configured with multi-PDSCH scheduling and CBG-based transmission, and at least another one of the CCs is not configured with CBG-based transmission, i.e., configured with TB-based transmission, and configured with multi-PDSCH scheduling.

As shown in FIG. 2, the network device 120 transmits 205 a parameter PDSCH-CodeBlockGroupTransmission and a first DCI for multi-PDSCH scheduling (configured with a TDRA table containing at least one row with multiple SLIVs) for at least one of the N_{cells}^{DL} serving cells in the PUCCH cell group.

The network device 120 transmits 210 multiple CBG-based transmissions scheduled by the first DCI, and at least one TB-based transmission to the terminal device 110. Additionally, the network device 120 may further transmit a single CBG-based transmission scheduled by a fourth DCI. In some example embodiments, the at least one TB-based transmission may comprise a single TB-based transmission scheduled by a second DCI and multiple TB-based transmissions scheduled by a third DCI.

Upon receipt of the transmissions, the terminal device 110 generates 215 a HARQ-ACK codebook comprising HARQ feedbacks of the multiple CBG-based transmissions and the at least one TB-based transmission to the network device 120. The HARQ-ACK codebook may comprise a plurality of sub-codebooks. FIGS. 3-5 show different designs of the HARQ-ACK codebook.

The terminal device 110 transmits 220 the HARQ-ACK codebook to the network device 120. For example, the HARQ-ACK codebook may be transmitted on Physical Uplink Control Channel (PUCCH).

The HARQ-ACK codebook can be constructed to be various format, which may depend on the network configurations, specified rules, network conditions and so on. Various embodiments of HARQ-ACK codebook designs will be described below in connection with FIGS. 3-5.

In some example embodiments, the terminal device 110 may generate a HARQ-ACK codebook comprises two sub-codebooks, i.e., a first sub-codebook for HARQ feedbacks of CBG-based transmissions, and a second sub-codebook for HARQ feedbacks of the at least one TB-based transmission. FIG. 3 illustrates a schematic diagram illustrating an example HARQ-ACK codebook 300 according to embodiments of the present disclosure.

As shown in FIG. 3, the HARQ-ACK codebook 300 comprises the second sub-codebook 301 and the first sub-codebook 302. The second sub-codebook 301 comprises HARQ feedbacks of TB-based transmissions, which include a single TB-based transmission scheduled by a second DCI and multiple TB-based transmissions scheduled by a third DCI, the SPS-PDSCH release indication, the SCell dormancy indication, and so on. The first sub-codebook 302 comprises HARQ feedbacks of CBG-based transmissions, which include multiple CBG-based transmissions scheduled by the first DCI and a single CBG-based transmission scheduled by a fourth DCI. The first sub-codebook 302 immediately follows the second sub-codebook 301. In addition, HARQ-ACK bits for receipt of SPS data transmissions (such as, SPS PDSCH reception) may be included in the second sub-codebook 301, as shown in FIG. 3. Alternatively, such information may be behind the end of the first sub-codebook 302.

In some example embodiments, the terminal device 110 may generate a HARQ-ACK codebook comprises three sub-codebooks, i.e., a first sub-codebook for HARQ feedbacks of CBG-based transmissions, a second sub-codebook for HARQ feedbacks of the single TB-based transmission scheduled by the second DCI, and a third sub-codebook for HARQ feedbacks of the multiple TB-based transmission scheduled by the third DCI.

In the example as shown in FIG. 3, the second sub-codebook 301 is designed and provided for the following cases:
Any DCI that is not configured with CBG-based transmission scheduling and is configured with TDRA table containing rows each with a single SLIV;
Any DCI that is not configured with CBG-based transmission scheduling and is configured with TDRA table containing at least one row with multiple SLIVs and schedules only a single PDSCH;
Any DCI that is not configured with CBG-based transmission scheduling and configured with TDRA table containing at least one row with multiple SLIVs and schedules multiple PDSCHs;
Any DCI that is configured with CBG-based transmission scheduling but TB-based PDSCH scheduling, such as DCI format 1_0/1_2;
The HARQ-ACK for any DCI used for SPS PDSCH release indication and SCell dormancy indication without scheduled PDSCH.
   The first sub-codebook 301 is designed and provided for the following case:
Any DCI that is configured with CBG-based transmission scheduling and schedule CBG-based transmission PDSCH.

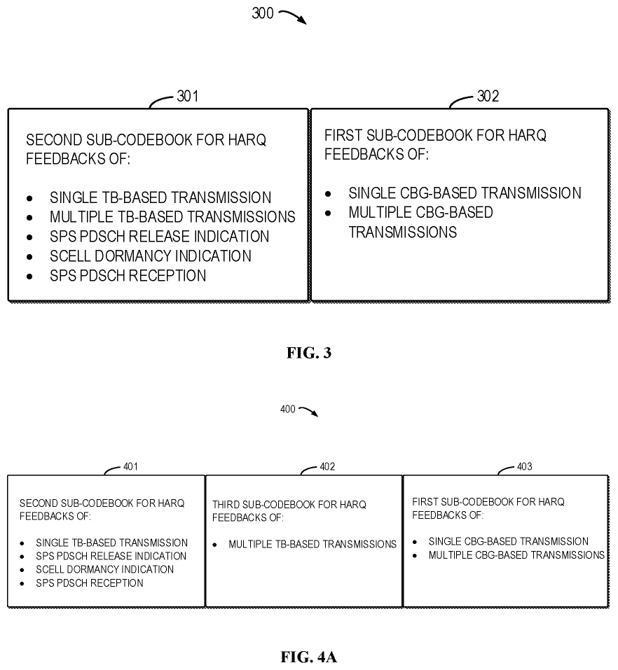

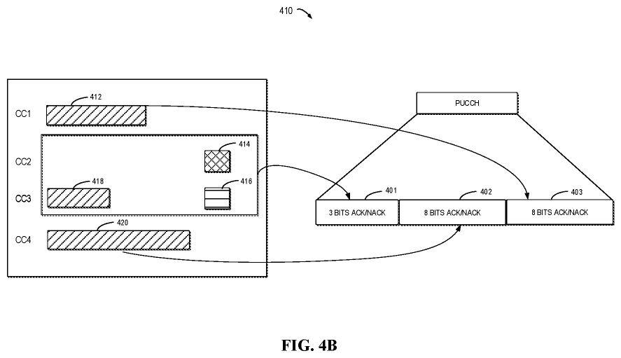

FIG. 4A illustrates a schematic diagram illustrating another example HARQ-ACK codebook 400 according to embodiments of the present disclosure. As shown in FIG. 4A, the HARQ-ACK codebook 400 may be constructed as the second sub-codebook 401, the third sub-codebook 402 and the first sub-codebook 403 from front to back. Further, the HARQ-ACK codebook 400 may be transmitted to the network device 120 on PUCCH. In particular, the second sub-codebook 401 comprises HARQ feedbacks of a single TB-based transmission scheduled by the second DCI, the SPS-PDSCH release indication, the SCell dormancy indication, and so on. The third sub-codebook 402 comprises HARQ feedbacks of the multiple TB-based transmissions scheduled by the third DCI. The first sub-codebook 403 comprises HARQ feedbacks of CBG-based transmissions, which include multiple CBG-based transmissions scheduled by the first DCI and the single CBG-based transmission scheduled by the fourth DCI, as previously described. In addition, HARQ-ACK bits for receipt of SPS data transmissions may be included in the second sub-codebook 401, as shown in FIG. 4.A. Alternatively, such information may be behind the end of the first sub-codebook 403.

In the example as shown in FIG. 4A, the second sub-codebook 401 is designed and provided for the following cases:
Any DCI that is not configured with CBG-based scheduling and is configured with a TDRA table containing rows each with a single SLIV;
Any DCI that is not configured with CBG-based scheduling and is configured with a TDRA table containing at least one row with multiple SLIVs and schedules only a single PDSCH; and
The HARQ-ACK for any DCI used for SPS PDSCH release indication and SCell dormancy indication without scheduled PDSCH.
   The third sub-codebook 402 is designed and provided for the following cases:
Any DCI that is not configured with CBG-based scheduling and configured with a TDRA table containing at least one row with multiple SLIVs and schedules multiple PDSCHs.
   And, the first sub-codebook 403 is designed and provided for the following cases:
Any DCI that is configured with CBG-based scheduling and is configured with a TDRA table containing rows each with a single SLIV and schedules multiple PDSCHs;
Any DCI that is configured with CBG-based scheduling and is configured with a TDRA table containing at least one row with multiple SLIVs and schedules only a single PDSCH.

The HARQ-ACK payload for different DCI for the same serving cell is semi static, and if any of the different DCI is not detected for a specific serving cell, that is, the counter-downlink assignment index (C-DAI) value is not the same as the DCI number detected by the terminal device 110, then the terminal device 110 will know how many NACK bits will be padded, and the reliability can be reached.

In the embodiments where both the parameter PDSCH-CodeBlockGroupTransmission and multi-PDSCH scheduling are configured for a specific serving cell, the number of HARQ-ACK bits for a DAI in the DCI from the network device 120 may be determined based on a maximum number of CBGs configured for a single TB, denoted by N_{CBG}, and a maximum number of transmissions schedulable by all serving cells, denoted by N_{PDSCH}. In this case, the size of the first sub-codebook 403 may be determined based on the DAI, the maximum number of CBGs, and maximum number of transmissions schedulable by all serving cells that multi-PDSCH scheduling and CBG-based transmission are not jointly configured. For example, the size of the first sub-codebook 403 may be determined to be value (DAI)*N_{CBG}*N_{PDSCH}.

In some example embodiments, the size of the first sub-codebook for each DAI may be based on the maximum number of schedulable transmissions with CBG-based transmission not being configured. FIG. 4B illustrates a schematic diagram illustrating an example size of the HARQ-ACK codebook 410 with three sub-codebooks 401 to 403 according to embodiments of the present disclosure. As shown in FIG. 4B, CC1 is configured for multiple CBG-level transmissions 412 scheduled by the first DCI, CC2 and CC3 are configured for single TB-based transmission 418 scheduled by the second DCI, the SPS PDSCH release indication 414, the SCell dormancy indication 416 and so on. The CC4 is configured for multiple TB-based transmissions 420 scheduled by the third DCI. The maximum number of transmissions that can be scheduled with a single DCI is configured to be 8 in CC4 and thus the size of the second sub-codebook 402 for multiple-TB based transmission scheduling is 8 bits. For CC1, the maximum number of CBGs for one TB is 2 and the maximum number of transmissions that can be scheduled with a single DCI configured is 4, and thus the size of the first sub-codebook 403 may be 8 bits.

In some example embodiments, the terminal device 110 may generate a HARQ-ACK codebook comprises four sub-codebooks, i.e., a first sub-codebook for HARQ feedbacks of the multiple CBG-based transmissions scheduled by the first DCI, a second sub-codebook for HARQ feedbacks of the single TB-based transmission scheduled by the second DCI, a third sub-codebook for HARQ feedbacks of the multiple TB-based transmission scheduled by the third DCI, and a fourth sub-codebook for single CBG-based transmission scheduled by a fourth DCI.

FIG. 5 illustrates a schematic diagram illustrating still another example HARQ-ACK codebook 500 according to embodiments of the present disclosure. As shown in FIG. 5, the HARQ-ACK codebook 500 may be constructed as the second sub-codebook 501, the third sub-codebook 502, the fourth sub-codebook 503 and the first sub-codebook 504 from front to back. Likewise, the HARQ-ACK codebook 500 may be transmitted on PUCCH. In particular, the second sub-codebook 501 is similar to the second sub-codebook 401 as shown in FIG. 4A, and comprises HARQ feedbacks of a single TB-based transmission scheduled by the second DCI, the SPS-PDSCH release indication, the SCell dormancy indication, and so on. The third sub-codebook 502 is similar to the third sub-codebook 402 as shown in FIG. 4A, and comprises HARQ feedbacks of the multiple TB-based transmissions scheduled by the third DCI. The fourth sub-codebook 503 comprises HARQ feedbacks of single CBG-based transmission scheduled by the fourth DCI. The first sub-codebook 504 comprises HARQ feedbacks of multiple CBG-based transmissions scheduled by the first DCI. In addition, HARQ-ACK bits for receipt of SPS data transmissions may be included in the second sub-codebook 501, which is the case shown in FIG. 5. Alternatively, such information may be attached to the end of the first sub-codebook 504.

In the example as shown in FIG. 5, the second sub-codebook 501 is designed and provided for the following cases:
Any DCI that is not configured with CBG-based transmission scheduling and is configured with a TDRA table containing rows each with a single SLIV;
Any DCI that is not configured with CBG-based transmission scheduling and is configured with a TDRA table containing at least one row with multiple SLIVs and schedules only a single PDSCH;
The HARQ-ACK for SPS PDSCH release indication and SCell dormancy indication without scheduled PDSCH.
   The third sub-codebook 502 is designed and provided for the following case:
Any DCI that is not configured with CBG-based transmission scheduling and configured with a TDRA table containing at least one row with multiple SLIVs and schedules multiple PDSCHs.

The fourth sub-codebook 503 is designed and provided for the following case:
Any DCI that is configured with CBG-based transmission scheduling and is configured with a TDRA table containing rows each with a single SLIV.
   The first sub-codebook 504 is designed and provided for the following case:
Any DCI that is configured with CBG-based scheduling and is configured with a TDRA table containing at least one row with multiple SLIVs and schedules multiple PDSCH.

In the case where the HARQ-ACK codebook comprises four sub-codebooks as shown in FIG. 5, the size of the fourth sub-codebook 503 for a DAI in single DCI may be based on the maximum number of CBGs configured for a TB. Moreover, the size of the first sub-codebook 504 for a DAI in single DCI may be based on the maximum number of CBGs, N_{CBG}, and the maximum number of transmissions schedulable by a single DCI, N_{PDSCH}. For example, the size of the first sub-codebook 504 may be determined to be N_{CBG}*N_{PDSCH}.

Such separate sub-codebooks may be generated for any DCI that is configured with CBG-based transmission scheduling and is configured with a TDRA table containing rows each having a single SLIV and schedules multiple PDSCH transmissions and any DCI that is configured with CBG-based transmission scheduling and is configured with a TDRA table containing at least one row with multiple SLIVs and schedules only a single PDSCH. By constructing the HARQ-ACK codebook with four separate sub-codebooks, less padding NACK bits will be introduced and the overhead of the HARQ-ACK codebook can be reduced.

The number of sub-codebooks to be included in HARQ-ACK codebook may be specified, preconfigured, indicated by the network device 120, or determined by the terminal device 110.

In some example embodiments, the number of the sub-codebooks for the HARQ-ACK codebook may be determined based on downlink transmission configurations. For example, if the terminal device 110 is not configured with the parameter PDSCH-CodeBlockGroupTransmission for all N_{cells}^{DL} serving cells in the PUCCH cell group, and configured with a TDRA table containing at least one row with multiple SLIVs, the HARQ-ACK codebook may be constructed as including only two sub-codebooks. Otherwise, if the terminal device 110 is configured with the parameter PDSCH-CodeBlockGroupTransmission for at least one of the serving cells in the PUCCH cell group and configured with a TDRA table containing at least one row with multiple SLIVs, either two or three sub-codebooks are supported for constructing the HARQ-ACK codebook.

In some other example embodiments, the network device 120 may indicate whether two sub-codebooks, three sub-codebooks or four sub-codebooks are supported constructing the HARQ-ACK codebook via signaling. For example, if the network device 120 transmits a RRC configuration parameter that is set to a first value, the terminal device 110 may determine three sub-codebooks are supported for constructing the HARQ-ACK codebook. If the network device 120 transmits the RRC configuration parameter that is set to a second value different from the first value, the terminal device 110 may then determine two sub-codebooks are supported for constructing the HARQ-ACK codebook. Further, if the network device 120 transmits the RRC configuration parameter that is set to a third value different from the first and second values, the terminal device 110 may determine fourth sub-codebooks are supported for constructing the HARQ-ACK codebook.

In some example embodiments, the C-DAI or the total-DAI is counted per DCI during generation of the Type-2 HARQ-ACK codebook. Since separate sub-codebooks are supported for reporting the HARQ feedbacks of single/multiple transmission scheduling, the network device 120 may need to configure one or more additional DAI field in the UL DCI. An additional DAI field, for example, two additional bits may be added in the DCI for indicating the size of the first sub-codebook. The other four DAI existing in DCI is used for indicating other DCI except for multiple TB-based transmission scheduling, and the C-DAI value and the total DAI value may apply separately for each of the sub-codebooks in the HARQ-ACK codebook. For the case of four sub-codebooks supported for the HARQ-ACK codebook, another additional DAI field, i.e., another two additional bits are added in the DCI for indicating the size of the fourth sub-codebook.

In some example embodiments, the number of CBGs configured for a TB in the multiple CBG-based transmissions scheduled by a single DCI may be different from the number of CBGs configured for a TB in the single CBG-based transmission scheduled by a single DCI. In other words, the HARQ feedbacks of multiple CBG-based transmission scheduling are not aligned with the HARQ feedbacks of single CBG-based transmission scheduling. For example, it is possible for the carrier(s) that configured with a TDRA table containing rows each having a single SLIV to be configured with 8 CBGs (i.e., the number of CBSs is 8), while for the carrier(s) that configured with a TDRA table containing rows each having multiple SLIV to be configured with 2 CBGs (i.e., the number of CBSs is 2). As such, the size of the sub-codebooks for the carriers that is configured multiple PDSCH scheduling and CBG-based transmission can be reduced.

In some scenarios, time domain or spatial domain bundling may be supported in generating HARQ feedbacks of multiple CBG-based transmissions scheduled by a single DCI. In this way, the size of the sub-codebooks for the carriers that is configured multiple PDSCH scheduling and CBG-based transmission can be reduced.

In the embodiments where the terminal device 110 is configured with multi-PDSCH scheduling and CBG-based transmission, if a first condition is met, the terminal device 110 may then generate the HARQ codebook comprising the HARQ feedbacks of the multiple CBG-based transmissions bundled in the time domain.

In some example embodiments, the first condition may include the maximum number of CBGs configured for a TB exceeding a CBG threshold. Or alternatively, the first condition may include the maximum number of transmissions schedulable by a single DCI exceeding a scheduled number threshold. In these embodiments, if the first condition is met, the terminal device 110 may generate a sub-codebook comprising HARQ feedbacks of multiple CBG-based transmissions bundled in time domain. Depending on the number of the sub-codebooks supported for the HARQ-ACK codebook, such a sub-codebook may be the first sub-codebook or the fourth sub-codebook as previously described.

In some example embodiments, the first condition may include a RRC configuration parameter indicative of time bundling being received from the network device 120. For example, the RRC configuration parameter may be harq-ACK-TimeBundlingPUCCH in PhysicalCellGroupConfig IE. If the RRC configuration parameter is received, the terminal device 110 may generate a sub-codebook comprising HARQ feedbacks of multiple CBG-based transmissions bundled in time domain. Likewise, such a sub-codebook may be the first sub-codebook or the fourth sub-codebook as previously described, which depends on the number of the sub-codebooks supported for the HARQ-ACK codebook.

In some example embodiments, the first condition may include a first bit in the first DCI being configured with a first value. The first bit may be any bit in the first DCI. For example, if a specific bit in the first DCI, which may be the DCI format1_1/1_2 is set to the first value, the terminal device 110 determines that the time bundling for HARQ feedbacks is enabled, and in this case, the terminal device 110 may generate a sub-codebook comprising HARQ feedbacks of multiple CBG-based transmissions bundled in time domain. Otherwise, if the specific bit in the first DCI is set to a second value different from the first value, the terminal device 110 determines that the time bundling for HARQ feedbacks is disabled.

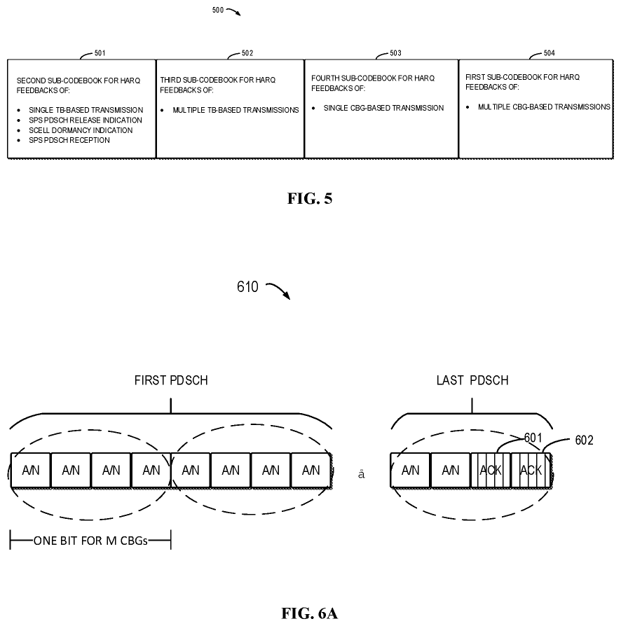

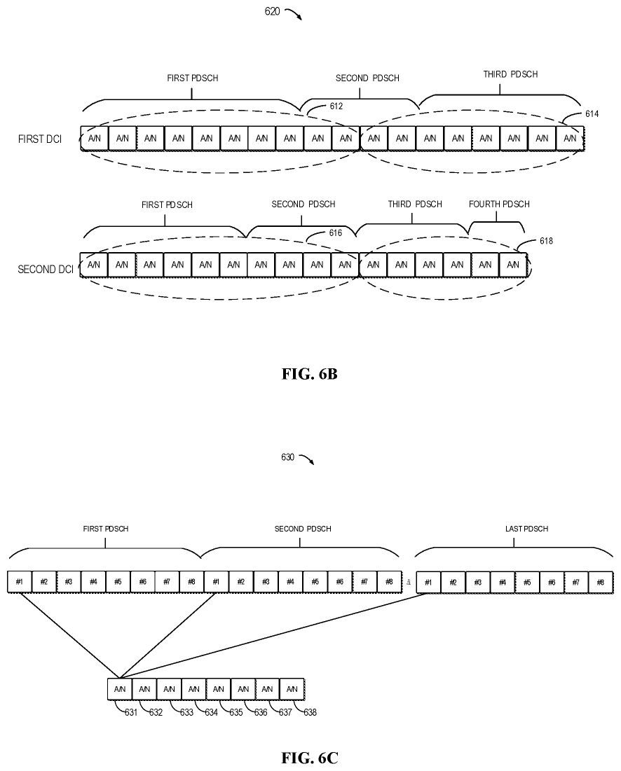

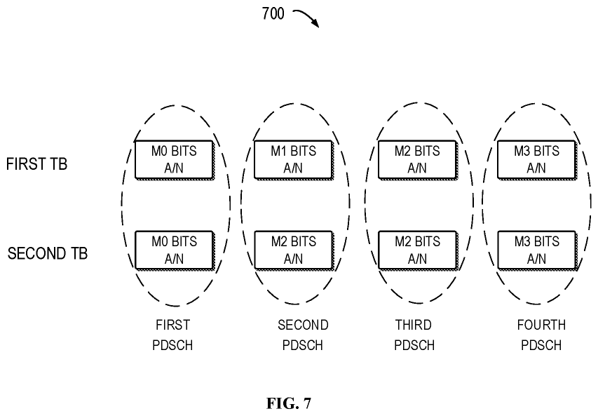

The HARQ feedbacks of multiple CBG-based transmissions scheduled by a single DCI, that is, the HARQ feedbacks in the same sub-codebook, may be bundled in time domain based on different rules, which will be discussed below in connection with FIGS. 6A-6C.

FIG. 6A illustrates a schematic diagram illustrating an example bundling for HARQ feedbacks of multi-downlink data channel scheduling by a single DCI in time domain according to embodiments of the present disclosure. As shown in FIG. 6A, multiple CBG-based transmissions from the first PDSCH to the last PDSCH are scheduled by a single DCI. A time bundling window is configured for the CBGs scheduled on the multiple PDSCHs, and a size of the time bundling window may be set to M. With the time bundling window; every M consecutive CBGs or HARQ-ACK bits may be grouped into a time bundling group, and one bit is configured for a single time bundling group. As such, the HARQ-ACK bits for one DCI is equal to ceil (N_{CBG}*N_{PDSCH}/M). In the example of FIG. 6A, the bundling size M is 4, however, it should be understood that any other integer number may also be possible. If the number of ACK/NACK bits for HARQ feedbacks for the multiple CBG-based transmissions on multiple PDSCHs is not an integer of M or the number of CBGs or HARQ-ACK bits in the last time bundling group is not equal to M, one or more ACK bit should be padded. For example, for the last time bundling group including only 6 CBGs which is less than M, two ACK bits may be used for padding. For example, 6 CBGs are scheduled on the last PDSCH, and thus the last time bundling group includes only 2 CBGs. In this case, two ACK bits, e.g., ACK 601 and 602, are padded to form a 4-CBG time bundling group.

In this way, the HARQ-ACK bits of M CBGs of each TB are bundled in time domain, or alternatively, the HARQ-ACK bits of n CBGs of m TBs are bundled in time domain, with m+n=M, the terminal device 110 may generate a single HARQ-ACK feedback for the CBG(s)/PDSCHs that belong to the same time bundling group.

FIG. 6B illustrates a schematic diagram illustrating another example bundling for HARQ feedbacks of multi-downlink data channel scheduling by a single DCI in time domain according to embodiments of the present disclosure. In the example of FIG. 6B, a number of time bundling group p is configured by a RRC message. That is, for each DCI, no matter how many PDSCHs and how many CBGs are configured for one TB, only p bits HARQ-ACK feedback are configured for one DAI in a corresponding DCI.

In some example embodiments, the number of ACK/NACK bits for each time bundling group may be different. As shown in FIG. 6B, the number of time bundling group p is set to 2, there are three PDSCHs scheduled by the first DCI and four PDSCHs scheduled by the second DCI. The first group 612 for first DCI corresponds to 10 CBGs, the second group 614 for first DCI corresponds to 8 CBGs, the first group 616 for second DCI corresponds to 10 CBGs and the second group 618 for second DCI corresponds to 6 CBGs.

In some example embodiments, the terminal device 110 may determine which of ACK/NACK bits are included in each of the time bundling groups based on various rules. For example, the first N time bundling groups may be determined to include T/p ACK/NACK bits and the last p−N time bundling group may be determined to include (m−N*P)*(p−N) ACK/NACK bits. For example, the time bundling group number p may be configured to be 2, and in this case for each DCI, the terminal device 110 may feedback 2 HARQ-ACK bits. In a case that one DCI is not detected, the corresponding sub-codebook may be padded by 2 NACK bits.

FIG. 6C illustrates a schematic diagram illustrating yet another example bundling for HARQ feedbacks of multi-downlink data channel scheduling by a single DCI in time domain according to embodiments of the present disclosure. In the example of FIG. 6C, HARQ-ACK bits corresponding to the same CBG index from different PDSCHs may be grouped into a time bundling group, and one bit is configured for single time bundling group. In some example embodiments, the number of CBGs for each of the scheduled PDSCHs is the same, and the ACK/NACK bits are equal to the maximum number of CBGs configured for this serving cell. Otherwise, ACK bits may be padded in the PDSCH with a smaller number of CBGs.

In some scenarios, a first indication for transmission of HARQ feedbacks bundled in time domain and a second indication for transmission of HARQ feedbacks bundled in spatial domain may be configured for multiple TB-based transmissions for one serving cell. For example, the first indication may be harq-ACK-TimeBundling, and the first indication may be harq-ACK-SpatialBundling. The terminal device 110 is also configured with maxNrofCodeWordsScheduledByDCI for reception of two TBs.

In some embodiments where TB-based transmission is configured, if both harq-ACK-SpatialBundlingPUCCH and harq-ACK-TimeBundlingPUCCH are configured, it is specified that pseudo-code operation harq-ACK-SpatialBundlingPUCCH is not enabled. In other words, in this case, the terminal device 110 may perform time bundling in generating the HARQ feedback for the multiple TB-based transmissions, and ignore the second indication of spatial bundling.

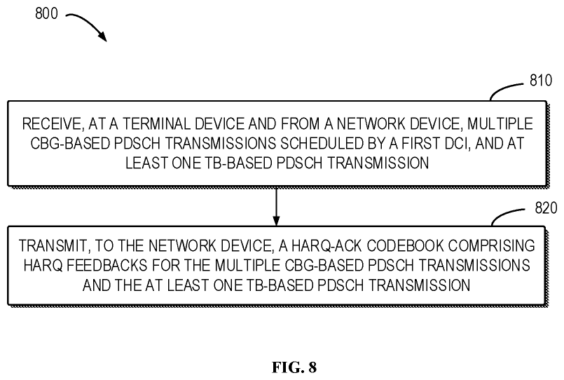

In some embodiments where TB-based transmission is configured, if both harq-ACK-SpatialBundlingPUCCH and harq-ACK-TimeBundlingPUCCH are configured and the terminal device 110 is configured with maxNrofCodeWordsScheduledByDCI for reception of two TBs for at least one DL BWP of at least one serving cell, the terminal device 110 may perform spatial bundling at TB level for each PDSCH of the two codeword, that is, the harq-ACK-SpatialBundling is enabled, and ignore harq-ACK-TimeBundlingPUCCH. FIG. 7 illustrates a schematic diagram illustrating an example bundling for HARQ feedbacks of multiple CBG-based transmissions scheduled by a single DCI in spatial domain according to embodiments of the present disclosure. As shown in FIG. 7, the first device 110 is configured with the first TB and the second TB, and there are multiple CBGs configured for each TB. The HARQ feedbacks for CBGs for the first and second TBs are bundled in spatial domain.

In some example embodiments, the terminal device 110 may determine to use whether the time bundling or the spatial bundling generating the HARQ feedback for the multiple TB-based transmissions based on the maximum number of transmissions schedulable by a single DCI, i.e., N_{PDSCH}. By way of example, the terminal device 110 is configured with maxNrofCodeWordsScheduledByDCI for reception of two TBs and two TBs are received for each PDSCH. If the maximum number of transmissions N_{PDSCH} is less than 4, the terminal device 110 may determine that time bundling is used for generating the HARQ feedback for each TB. Additionally or alternatively, for a PDCCH monitoring occasion with DCI format scheduling PDSCH reception or SPS PDSCH release indication or indicating SCell dormancy in the active DL BWP of a serving cell, when the terminal device 110 receives one TB for each PDSCH or a SPS PDSCH release indication or indicating SCell dormancy and the value of maxNrofCodeWordsScheduledByDCI is 2, the HARQ-ACK information is associated with the first TB and the terminal device 110 may generate HARQ-ACK information with value of ACK for the second TB for time bundling.

Otherwise, if the maximum number of transmissions N_{PDSCH} is not less than 4, the terminal device 110 may determine that the spatial bundling is used for is used for generating the HARQ feedback for each TB.

In some scenarios, a first indication for transmission of HARQ feedbacks bundled in time domain and a second indication for transmission of HARQ feedbacks bundled in spatial domain may be configured for multiple CBG-based transmissions for one serving cell. For example, the first indication may be harq-ACK-TimeBundling, and the first indication may be harq-ACK-SpatialBundling. The terminal device 110 is also configured with maxNrofCodeWordsScheduledByDCI for reception of two TBs.

In some embodiments where CBG-based transmission is configured, if both harq-ACK-SpatialBundlingPUCCH and harq-ACK-TimeBundlingPUCCH are configured and the terminal device 110 is configured with maxNrofCodeWordsScheduledByDCI for reception of two TBs, the terminal device 110 may perform spatial bundling at TB level for each PDSCH of the two codeword, that is, the harq-ACK-SpatialBundling is enabled, and ignore harq-ACK-TimeBundlingPUCCH.

In some embodiments where CBG-based transmission is configured, if both harq-ACK-SpatialBundlingPUCCH and harq-ACK-TimeBundlingPUCCH are configured, it is specified that pseudo-code operation harq-ACK-SpatialBundlingPUCCH is not enabled. In other words, in this case, the terminal device 110 may perform time bundling in generating the HARQ feedback for the multiple CBG-based transmissions, and ignore the second indication of spatial bundling.

In some embodiments where CBG-based transmission is configured, if both harq-ACK-SpatialBundlingPUCCH and harq-ACK-TimeBundlingPUCCH are configured and the terminal device 110 is configured with maxNrofCodeWordsScheduledByDCI for reception of two TBs for at least one DL BWP of at least one serving cell, the terminal device 110 may perform spatial bundling at CBG level for each PDSCH of the two codeword, that is, the harq-ACK-SpatialBundling is enabled, and ignore harq-ACK-TimeBundlingPUCCH.

In some example embodiments, the terminal device 110 may determine to use whether the time bundling or the spatial bundling generating the HARQ feedback for the multiple CBG-based transmissions based on the maximum number of transmissions schedulable by a single DCI, i.e., N_{PDSCH}. By way of example, the terminal device 110 is configured with maxNrofCodeWordsScheduledByDCI for reception of two TBs and two TBs are received for each PDSCH. If the maximum number of transmissions N_{PDSCH} is not exceeding a scheduled number threshold, the terminal device 110 may determine that time bundling is used for generating HARQ feedbacks of the multiple CBG-based transmissions. Otherwise, if the maximum number of transmissions N_{PDSCH} exceeds the scheduled number threshold, the terminal device 110 may determine that spatial bundling is used for generating HARQ feedbacks of the multiple CBG-based transmissions.

In some example embodiments, the terminal device 110 may determine to use whether the time bundling or the spatial bundling generating the HARQ feedback for the multiple CBG-based transmissions based on the maximum number of CBGs configured for a TB, i.e., N_{CBG}. By way of example, the terminal device 110 is configured with maxNrofCodeWordsScheduledByDCI for reception of two TBs and two TBs are received for each PDSCH. If the maximum number of CBGs N_{CBG} is not exceeding a CBG number threshold, the terminal device 110 may determine that time bundling is used for generating HARQ feedbacks of the multiple CBG-based transmissions. Otherwise, if the maximum number of CBGs N_{CBG} exceeds the scheduled number threshold, the terminal device 110 may determine that spatial bundling is used for generating HARQ feedbacks of the multiple CBG-based transmissions

It is to be understood that the number of PDSCHs scheduled in one PDCCH is not limited to the above example, and any other integer larger may also be feasible.

### Example Implementation of Methods

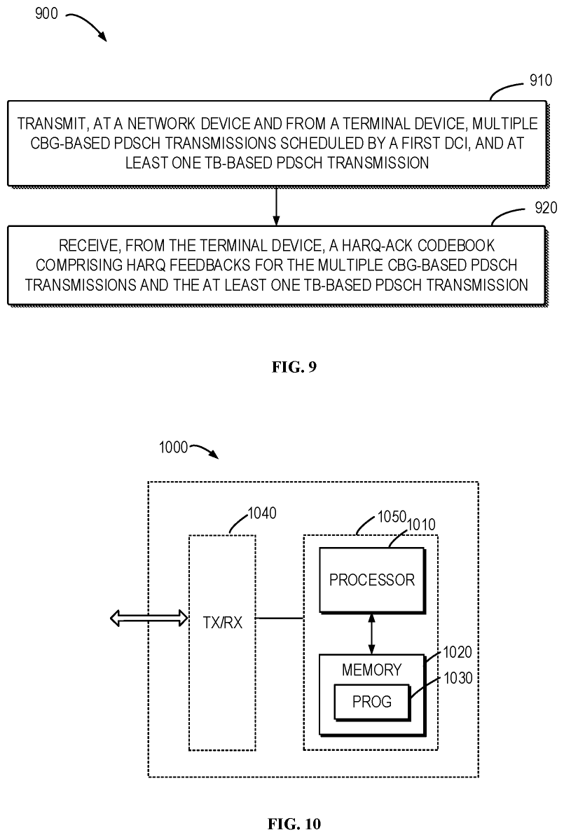

Accordingly, embodiments of the present disclosure provide methods of communication implemented at a terminal device and a network device. These methods will be described below with reference to FIGS. 8-9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives, from the network device 120, multiple CBG-based PDSCH transmissions scheduled by a first DCI, and at least one TB-based PDSCH transmission.

At block 820, the terminal device 110 transmits, to the network device 120, a HARQ-ACK codebook comprising HARQ feedbacks of the multiple CBG-based PDSCH transmissions and the at least one TB-based PDSCH transmission.

In some example embodiments, the HARQ-ACK codebook may comprise a first sub-codebook for HARQ feedbacks of the multiple CBG-based PDSCH transmissions, and a second sub-codebook for HARQ feedbacks of the at least one TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise HARQ feedbacks of the TB-based PDSCH transmission and the multiple TB-based PDSCH transmissions. In these embodiments, the first sub-codebook follows the second sub-codebook.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise a HARQ feedback of the TB-based PDSCH transmission, and the HARQ codebook may further comprise a third sub-codebook of HARQ feedbacks of the multiple TB-based PDSCH transmissions. In these embodiments, the third sub-codebook immediately follows the second sub-codebook and the first sub-codebook follows the third sub-codebook.

In some example embodiments, the terminal device 110 may receive, from the network device 120, a CBG-based PDSCH transmission scheduled by a fourth DCI. In these embodiments, the first sub-codebook may further comprise HARQ feedbacks of the CBG-based PDSCH transmission.

In some example embodiments, the terminal device 110 may receive, from the network device 120, a CBG-based PDSCH transmission scheduled by a fourth DCI. In these embodiments, the HARQ-ACK codebook further comprises a fourth sub-codebook for CBG-based HARQ feedback of the CBG-based PDSCH transmission, the fourth sub-codebook follows the second sub-codebook, and the first sub-codebook immediately follows the fourth sub-codebook.

In some example embodiments, the number of CBGs configured for a TB in the multiple CBG-based PDSCH transmissions is different from the number of CBGs configured for a TB in the CBG-based PDSCH transmission.

In some example embodiments, the HARQ feedbacks of the multiple CBG-based PDSCH transmissions may be bundled in time domain. In some example embodiments, the terminal device 110 may determine whether a first condition is met. If the first condition is met, the terminal device 110 may generate the HARQ codebook comprising the HARQ feedbacks of the multiple CBG-based PDSCH transmissions bundled in the time domain.

In the above embodiments, the first condition may comprise one of the following: a maximum number of CBGs for a TB exceeding a CBG threshold, a RRC configuration parameter received from the network device 120, or a first bit in the first DCI configured with a first value.

In some example embodiments, a corresponding one of the first sub-codebook and the fourth sub-codebook comprises a HARQ feedback for every group of M CBGs for the multiple CBG-based PDSCH transmission. In some example embodiments, the corresponding one of the first sub-codebook and the fourth sub-codebook may further comprise a HARQ feedback for a group of less than M CBGs comprising at least one padding ACK bit.

In some example embodiments, CBGs for the multiple CBG-based PDSCH transmissions may be grouped into a first number of groups and a corresponding one of the first sub-codebook and the fourth sub-codebook comprises a first number of HARQ feedbacks of the first number groups of CBGs.

In some example embodiments, a corresponding one of the first sub-codebook and the fourth sub-codebooks may comprise a HARQ feedback for CBGs with the same index but from different CBG-based PDSCH transmissions.

In some example embodiments, the terminal device 110 may receive uplink DCI comprising a field for the first sub-codebook. In these embodiments, a payload size of the first sub-codebook is based on a maximum number of CBGs for a TB and a maximum number of transmissions schedulable by a single DCI.

In some example embodiments, the uplink DCI may further comprise a field for a fourth sub-codebook for a HARQ feedback of a CBG-based PDSCH transmission scheduled by a fourth DCI, and a payload size of the fourth sub-codebook is based on a maximum number of CBGs for a TB schedulable by a single DCI.

In some example embodiments, the at least one TB-based PDSCH transmission may comprise a TB-based PDSCH transmission scheduled by a second DCI and multiple TB-based PDSCH transmissions scheduled by a third DCI. In these embodiments, to transmit the HARQ-ACK codebook, the terminal device 110 may determine whether a maximum number of transmissions schedulable by a single DCI exceeds a scheduled number threshold. If the maximum number of transmissions schedulable by the single DCI exceeds the scheduled number threshold, the terminal device 110 may transmit the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions. If the maximum number of transmissions schedulable by the single DCI is not exceeding the scheduled number threshold, the terminal device 110 may transmit the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI. In these embodiments, to transmit the HARQ-ACK codebook, the terminal device 110 may determine whether a configuration parameter received from the network device 120 is set to a first value or a second value. If the configuration parameter is set to the first value, the terminal device 110 may transmit the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions. If the configuration parameter is set to a second value, the terminal device 110 may transmit the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

In some example embodiments, the second sub-codebook may comprise HARQ-ACK bits for receipt of SPS data transmissions. In some example embodiments, the HARQ-ACK bits for receipt of SPS data transmissions may be behind the end of the second sub-codebook.

In some example embodiments, the at least one TB-based PDSCH transmission may comprise multiple TB-based PDSCH transmissions scheduled by a third DCI. In these embodiments, to transmit the HARQ codebook, the terminal device 110 may determine whether a maximum number of transmissions schedulable by a single DCI exceeds a scheduled number threshold. If the maximum number of transmissions schedulable by the single DCI is not exceeding the scheduled number threshold, the terminal device 110 may transmit the HARQ-ACK codebook comprising at least a second sub-codebook for HARQ feedbacks of the multiple TB-based PDSCH transmissions bundled in time domain. If the maximum number of transmissions schedulable by the single DCI exceeds the scheduled number threshold, the terminal device 110 may transmit the HARQ-ACK codebook comprising at least the second sub-codebook for HARQ feedbacks of the multiple TB-based PDSCH transmissions bundled in spatial domain.

In some example embodiments, the at least one TB-based PDSCH transmission may comprise multiple TB-based PDSCH transmissions scheduled by a third DCI. In these embodiments, to transmit the HARQ codebook, if both a first indication for transmission of HARQ feedbacks bundled in time domain and a second indication for transmission of HARQ feedbacks bundled in spatial domain are received, the terminal device 110 may transmit the HARQ-ACK codebook comprising at least a second sub-codebook for HARQ feedbacks of the multiple TB-based PDSCH transmissions bundled in spatial domain.

In some example embodiments, to transmit the HARQ codebook, the terminal device 110 may determine whether a maximum number of transmissions schedulable by a single DCI exceeds a scheduled number threshold. If the maximum number of transmissions schedulable by the single DCI is not exceeding the scheduled number threshold, the terminal device 110 may transmit the HARQ-ACK codebook comprising at least a first sub-codebook for HARQ feedbacks of the multiple CBG-based PDSCH transmissions bundled in time domain. If the maximum number of transmissions schedulable by the single DCI exceeds the scheduled number threshold, the terminal device 110 may transmit the HARQ-ACK codebook comprising at least a first sub-codebook for HARQ feedbacks of the multiple CBG-based PDSCH transmissions bundled in spatial domain.

In some example embodiments, to transmit the HARQ codebook, if both a first indication for transmission of HARQ feedbacks bundled in time domain and a second indication for transmission of HARQ feedbacks bundled in spatial domain are received, the terminal device 110 may transmit the HARQ-ACK codebook comprising at least a first sub-codebook for HARQ feedbacks of the multiple CBG-based PDSCH transmissions bundled in spatial domain.

FIG. 9 illustrates an example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the network device 120 transmits, from the terminal device 110, multiple CBG-based PDSCH transmissions scheduled by a first DCI, and at least one TB-based PDSCH transmission.

At block 920, the network device 120 receives, from the terminal device 110, a HARQ-ACK codebook comprising HARQ feedbacks of the multiple CBG-based PDSCH transmissions and the at least one TB-based PDSCH transmission.

In some example embodiments, the HARQ-ACK codebook may comprise a first sub-codebook for HARQ feedbacks of the multiple CBG-based PDSCH transmissions, and a second sub-codebook for HARQ feedbacks of the at least one TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise HARQ feedbacks of the TB-based PDSCH transmission and the multiple TB-based PDSCH transmissions. In these embodiments, the first sub-codebook follows the second sub-codebook.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise a HARQ feedback of the TB-based PDSCH transmission, and the HARQ codebook may further comprise a third sub-codebook of HARQ feedbacks of the multiple TB-based PDSCH transmissions. In these embodiments, the third sub-codebook immediately follows the second sub-codebook and the first sub-codebook follows the third sub-codebook.

In some example embodiments, the network device 120 may transmit, to the terminal device 110, a CBG-based PDSCH transmission scheduled by a fourth DCI. In these embodiments, the first sub-codebook further comprises a HARQ feedback of the CBG-based PDSCH transmission.

In some example embodiments, the network device 120 may transmit, to the terminal device 110, a CBG-based PDSCH transmission scheduled by a fourth DCI. In these embodiments, the HARQ-ACK codebook further comprises a fourth sub-codebook for a CBG-based HARQ feedback of the CBG-based PDSCH transmission, the fourth sub-codebook follows the second sub-codebook, and the first sub-codebook immediately follows the fourth sub-codebook.

In some example embodiments, the number of CBGs configured for a TB in the multiple CBG-based PDSCH transmissions may be different from the number of CBGs configured for a TB in the CBG-based PDSCH transmission.

In some example embodiments, the HARQ feedbacks of the multiple CBG-based PDSCH transmissions may be bundled in time domain.

In some example embodiments, a corresponding one of the first sub-codebook and the fourth sub-codebook may comprise a HARQ feedback for every group of M CBGs for the multiple CBG-based PDSCH transmission.

In some example embodiments, the corresponding one of the first sub-codebook and the fourth sub-codebook may further comprise a HARQ feedback for a group of less than M CBGs comprising at least one padding ACK bit.

In some example embodiments, CBGs for the multiple CBG-based PDSCH transmissions may be grouped into a first number of groups and a corresponding one of the first sub-codebook and the fourth sub-codebook comprises a first number of HARQ feedbacks of the first number groups of CBGs.

In some example embodiments, a corresponding one of the first sub-codebook and the fourth sub-codebook may comprise a HARQ feedback for CBGs with the same index but from different CBG-based PDSCH transmissions.

In some example embodiments, the network device 120 may transmit, to the terminal device 110, uplink DCI comprising a field for the first sub-codebook. In these embodiments, a payload size of the first sub-codebook is based on a maximum number of CBGs for a TB and a maximum number of transmissions schedulable by a single DCI.

In some example embodiments, the uplink DCI further comprises a field for a fourth sub-codebook for a HARQ feedback of a CBG-based PDSCH transmission scheduled by a fourth DCI, and a payload size of the fourth sub-codebook is based on a maximum number of CBGs for a TB schedulable by a single DCI.

In some example embodiments, the second sub-codebook may comprise HARQ-ACK bits for receipt of SPS data transmissions.

In some example embodiments, HARQ-ACK bits for receipt of SPS data transmissions may be behind the end of the second sub-codebook.

In some example embodiments, the at least one TB-based PDSCH transmission may comprise multiple TB-based PDSCH transmissions scheduled by a third DCI, and a maximum number of transmissions schedulable by a single DCI is not exceeding a scheduled number threshold. In these embodiments, the network device 120 may receive the HARQ-ACK codebook comprising at least a second sub-codebook for HARQ feedbacks of the multiple TB-based PDSCH transmissions bundled in time domain.

In some example embodiments, the at least one TB-based PDSCH transmission may comprise multiple TB-based PDSCH transmissions scheduled by a third DCI, and a maximum number of transmissions schedulable by a single DCI exceeds a scheduled number threshold. In these embodiments, the network device 120 may receive the HARQ-ACK codebook comprising at least a second sub-codebook for HARQ feedbacks of the multiple TB-based PDSCH transmissions bundled in spatial domain.

In some example embodiments, the network device 120 may transmit a first indication for transmission of HARQ feedbacks bundled in time domain. The network device 120 may transmit a second indication for transmission of HARQ feedbacks bundled in spatial domain. The network device 120 may receive the HARQ-ACK codebook comprising at least a second sub-codebook for HARQ feedbacks of the multiple TB-based PDSCH transmissions bundled in spatial domain.

In some example embodiments, a maximum number of transmissions schedulable by a single DCI may be not exceeding a scheduled number threshold. In these embodiments, the network device 120 may receive the HARQ-ACK codebook comprising at least a first sub-codebook for HARQ feedbacks of the multiple CBG-based PDSCH transmissions bundled in time domain.

In some example embodiments, a maximum number of transmissions schedulable by a single DCI may exceed a scheduled number threshold. In these embodiments, the network device 120 may receive the HARQ-ACK codebook comprising at least a first sub-codebook for HARQ feedbacks of the multiple CBG-based PDSCH transmissions bundled in spatial domain.

In some example embodiments, to receive the HARQ codebook, the network device 120 may transmit a first indication for transmission of HARQ feedbacks bundled in time domain, transmit a second indication for transmission of HARQ feedbacks bundled in spatial domain, and receive the HARQ-ACK codebook comprising at least a second sub-codebook for HARQ feedbacks of the multiple TB-based PDSCH transmissions bundled in spatial domain.

In this way, the HARQ-ACK codebook is adapted to report HARQ feedbacks in a case where CBG-based PDSCH transmission and multi-transmission scheduling are both configured. As such, the overhead of DCI can be reduced and the transmission efficiency can be improved.

### Example Implementation of Device

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: receive, from a network device, multiple code block group (CBG)-based PDSCH transmissions scheduled by a first downlink control information (DCI), and at least one transport block (TB)-based PDSCH transmission; and transmit, to the network device, a HARQ-acknowledgement (HARQ-ACK) codebook comprising HARQ feedbacks of the multiple CBG-based PDSCH transmissions and the at least one TB-based PDSCH transmission.

In some example embodiments, the HARQ-ACK codebook may comprise a first sub-codebook for HARQ feedbacks of the multiple CBG-based PDSCH transmissions, and a second sub-codebook for HARQ feedbacks of the at least one TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise HARQ feedbacks of the TB-based PDSCH transmission and the multiple TB-based PDSCH transmissions. In these embodiments, the first sub-codebook follows the second sub-codebook.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise a HARQ feedback of the TB-based PDSCH transmission, and the HARQ codebook may further comprise a third sub-codebook of HARQ feedbacks of the multiple TB-based PDSCH transmissions. In these embodiments, the third sub-codebook immediately follows the second sub-codebook and the first sub-codebook follows the third sub-codebook.

In some example embodiments, the circuitry may be configured to receive, from the network device 120, a CBG-based PDSCH transmission scheduled by a fourth DCI. In these embodiments, the first sub-codebook may further comprise HARQ feedbacks of the CBG-based PDSCH transmission.

In some example embodiments, the circuitry may be configured to receive, from the network device 120, a CBG-based PDSCH transmission scheduled by a fourth DCI. In these embodiments, the HARQ-ACK codebook further comprises a fourth sub-codebook for CBG-based HARQ feedback of the CBG-based PDSCH transmission, the fourth sub-codebook follows the second sub-codebook, and the first sub-codebook immediately follows the fourth sub-codebook.

In some example embodiments, the number of CBGs configured for a TB in the multiple CBG-based PDSCH transmissions is different from the number of CBGs configured for a TB in the CBG-based PDSCH transmission.

In some example embodiments, the HARQ feedbacks of the multiple CBG-based PDSCH transmissions may be bundled in time domain. In some example embodiments, the circuitry may be configured to determine whether a first condition is met. If the first condition is met, the circuitry may be configured to generate the HARQ codebook comprising the HARQ feedbacks of the multiple CBG-based PDSCH transmissions bundled in the time domain.

In the above embodiments, the first condition may comprise one of the following: a maximum number of CBGs for a TB exceeding a CBG threshold, a RRC configuration parameter received from the network device 120, or a first bit in the first DCI configured with a first value.

In some example embodiments, a corresponding one of the first sub-codebook and the fourth sub-codebook comprises a HARQ feedback for every group of M CBGs for the multiple CBG-based PDSCH transmission. In some example embodiments, the corresponding one of the first sub-codebook and the fourth sub-codebook may further comprise a HARQ feedback for a group of less than M CBGs comprising at least one padding ACK bit.

In some example embodiments, CBGs for the multiple CBG-based PDSCH transmissions may be grouped into a first number of groups and a corresponding one of the first sub-codebook and the fourth sub-codebook comprises a first number of HARQ feedbacks of the first number groups of CBGs.

In some example embodiments, a corresponding one of the first sub-codebook and the fourth sub-codebooks may comprise a HARQ feedback for CBGs with the same index but from different CBG-based PDSCH transmissions.

In some example embodiments, the circuitry may be configured to receive uplink DCI comprising a field for the first sub-codebook. In these embodiments, a payload size of the first sub-codebook is based on a maximum number of CBGs for a TB and a maximum number of transmissions schedulable by a single DCI.

In some example embodiments, the uplink DCI may further comprise a field for a fourth sub-codebook for a HARQ feedback of a CBG-based PDSCH transmission scheduled by a fourth DCI, and a payload size of the fourth sub-codebook is based on a maximum number of CBGs for a TB schedulable by a single DCI.

In some example embodiments, the at least one TB-based PDSCH transmission may comprise a TB-based PDSCH transmission scheduled by a second DCI and multiple TB-based PDSCH transmissions scheduled by a third DCI. In these embodiments, to transmit the HARQ-ACK codebook, the circuitry may be configured to may determine whether a maximum number of transmissions schedulable by a single DCI exceeds a scheduled number threshold. If the maximum number of transmissions schedulable by the single DCI exceeds the scheduled number threshold, the circuitry may be configured to may transmit the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions. If the maximum number of transmissions schedulable by the single DCI is not exceeding the scheduled number threshold, the circuitry may be configured to transmit the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI. In these embodiments, to transmit the HARQ-ACK codebook, the circuitry may be configured to determine whether a configuration parameter received from the network device 120 is set to a first value or a second value. If the configuration parameter is set to the first value, the circuitry may be configured to transmit the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions. If the configuration parameter is set to a second value, the circuitry may be configured to transmit the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

In some example embodiments, the second sub-codebook may comprise HARQ-ACK bits for receipt of SPS data transmissions. In some example embodiments, the HARQ-ACK bits for receipt of SPS data transmissions may be behind the end of the second sub-codebook.

In some example embodiments, the at least one TB-based PDSCH transmission may comprise multiple TB-based PDSCH transmissions scheduled by a third DCI. In these embodiments, to transmit the HARQ codebook, the circuitry may be configured to determine whether a maximum number of transmissions schedulable by a single DCI exceeds a scheduled number threshold. If the maximum number of transmissions schedulable by the single DCI is not exceeding the scheduled number threshold, the circuitry may be configured to transmit the HARQ-ACK codebook comprising at least a second sub-codebook for HARQ feedbacks of the multiple TB-based PDSCH transmissions bundled in time domain. If the maximum number of transmissions schedulable by the single DCI exceeds the scheduled number threshold, the circuitry may be configured to transmit the HARQ-ACK codebook comprising at least the second sub-codebook for HARQ feedbacks of the multiple TB-based PDSCH transmissions bundled in spatial domain.

In some example embodiments, the at least one TB-based PDSCH transmission may comprise multiple TB-based PDSCH transmissions scheduled by a third DCI. In these embodiments, to transmit the HARQ codebook, if both a first indication for transmission of HARQ feedbacks bundled in time domain and a second indication for transmission of HARQ feedbacks bundled in spatial domain are received, the circuitry may be configured to transmit the HARQ-ACK codebook comprising at least a second sub-codebook for HARQ feedbacks of the multiple TB-based PDSCH transmissions bundled in spatial domain.

In some example embodiments, to transmit the HARQ codebook, the circuitry may be configured to determine whether a maximum number of transmissions schedulable by a single DCI exceeds a scheduled number threshold. If the maximum number of transmissions schedulable by the single DCI is not exceeding the scheduled number threshold, the circuitry may be configured to transmit the HARQ-ACK codebook comprising at least a first sub-codebook for HARQ feedbacks of the multiple CBG-based PDSCH transmissions bundled in time domain. If the maximum number of transmissions schedulable by the single DCI exceeds the scheduled number threshold, the circuitry may be configured to transmit the HARQ-ACK codebook comprising at least a first sub-codebook for HARQ feedbacks of the multiple CBG-based PDSCH transmissions bundled in spatial domain.

In some example embodiments, to transmit the HARQ codebook, if both a first indication for transmission of HARQ feedbacks bundled in time domain and a second indication for transmission of HARQ feedbacks bundled in spatial domain are received, the circuitry may be configured to transmit the HARQ-ACK codebook comprising at least a first sub-codebook for HARQ feedbacks of the multiple CBG-based PDSCH transmissions bundled in spatial domain.

In some embodiments, a network device comprises circuitry configured to: transmit, from the terminal device 110, multiple CBG-based PDSCH transmissions scheduled by a first DCI, and at least one TB-based PDSCH transmission; and receive, from the terminal device 110, a HARQ-ACK codebook comprising HARQ feedbacks of the multiple CBG-based PDSCH transmissions and the at least one TB-based PDSCH transmission.

In some example embodiments, the HARQ-ACK codebook may comprise a first sub-codebook for HARQ feedbacks of the multiple CBG-based PDSCH transmissions, and a second sub-codebook for HARQ feedbacks of the at least one TB-based PDSCH transmission.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise HARQ feedbacks of the TB-based PDSCH transmission and the multiple TB-based PDSCH transmissions. In these embodiments, the first sub-codebook follows the second sub-codebook.

In some example embodiments, the at least one TB-based PDSCH transmission may comprise a TB-based PDSCH transmission scheduled by a second DCI and multiple TB-based PDSCH transmissions scheduled by a third DCI, the second sub-codebook may comprise a HARQ feedback of the TB-based PDSCH transmission, and the HARQ codebook may further comprise a third sub-codebook of HARQ feedbacks of the multiple TB-based PDSCH transmissions. In these embodiments, the third sub-codebook immediately follows the second sub-codebook and the first sub-codebook follows the third sub-codebook.

In some example embodiments, the circuitry may be configured to transmit, to the terminal device 110, a CBG-based PDSCH transmission scheduled by a fourth DCI. In these embodiments, the first sub-codebook further comprises a HARQ feedback of the CBG-based PDSCH transmission.

In some example embodiments, the circuitry may be configured to transmit, to the terminal device 110, a CBG-based PDSCH transmission scheduled by a fourth DCI. In these embodiments, the HARQ-ACK codebook further comprises a fourth sub-codebook for a CBG-based HARQ feedback of the CBG-based PDSCH transmission, the fourth sub-codebook follows the second sub-codebook, and the first sub-codebook immediately follows the fourth sub-codebook.

In some example embodiments, the number of CBGs configured for a TB in the multiple CBG-based PDSCH transmissions may be different from the number of CBGs configured for a TB in the CBG-based PDSCH transmission.

In some example embodiments, the HARQ feedbacks of the multiple CBG-based PDSCH transmissions may be bundled in time domain.

In some example embodiments, a corresponding one of the first sub-codebook and the fourth sub-codebook may comprise a HARQ feedback for every group of M CBGs for the multiple CBG-based PDSCH transmission.

In some example embodiments, the corresponding one of the first sub-codebook and the fourth sub-codebook may further comprise a HARQ feedback for a group of less than M CBGs comprising at least one padding ACK bit.

In some example embodiments, CBGs for the multiple CBG-based PDSCH transmissions may be grouped into a first number of groups and a corresponding one of the first sub-codebook and the fourth sub-codebook comprises a first number of HARQ feedbacks of the first number groups of CBGs.

In some example embodiments, a corresponding one of the first sub-codebook and the fourth sub-codebook may comprise a HARQ feedback for CBGs with the same index but from different CBG-based PDSCH transmissions.

In some example embodiments, the circuitry may be configured to transmit, to the terminal device 110, uplink DCI comprising a field for the first sub-codebook. In these embodiments, a payload size of the first sub-codebook is based on a maximum number of CBGs for a TB and a maximum number of transmissions schedulable by a single DCI.

In some example embodiments, the uplink DCI further comprises a field for a fourth sub-codebook for a HARQ feedback of a CBG-based PDSCH transmission scheduled by a fourth DCI, and a payload size of the fourth sub-codebook is based on a maximum number of CBGs for a TB schedulable by a single DCI.

In some example embodiments, the second sub-codebook may comprise HARQ-ACK bits for receipt of SPS data transmissions.

In some example embodiments, HARQ-ACK bits for receipt of SPS data transmissions may be behind the end of the second sub-codebook.

In some example embodiments, the at least one TB-based PDSCH transmission may comprise multiple TB-based PDSCH transmissions scheduled by a third DCI, and a maximum number of transmissions schedulable by a single DCI is not exceeding a scheduled number threshold. In these embodiments, the circuitry may be configured to receive the HARQ-ACK codebook comprising at least a second sub-codebook for HARQ feedbacks of the multiple TB-based PDSCH transmissions bundled in time domain.

In some example embodiments, the at least one TB-based PDSCH transmission may comprise multiple TB-based PDSCH transmissions scheduled by a third DCI, and a maximum number of transmissions schedulable by a single DCI exceeds a scheduled number threshold. In these embodiments, the circuitry may be configured to receive the HARQ-ACK codebook comprising at least a second sub-codebook for HARQ feedbacks of the multiple TB-based PDSCH transmissions bundled in spatial domain.

In some example embodiments, the circuitry may be configured to transmit a first indication for transmission of HARQ feedbacks bundled in time domain: transmit a second indication for transmission of HARQ feedbacks bundled in spatial domain; and receive the HARQ-ACK codebook comprising at least a second sub-codebook for HARQ feedbacks of the multiple TB-based PDSCH transmissions bundled in spatial domain.

In some example embodiments, a maximum number of transmissions schedulable by a single DCI may be not exceeding a scheduled number threshold. In these embodiments, the circuitry may be configured to receive the HARQ-ACK codebook comprising at least a first sub-codebook for HARQ feedbacks of the multiple CBG-based PDSCH transmissions bundled in time domain.

In some example embodiments, a maximum number of transmissions schedulable by a single DCI may exceed a scheduled number threshold. In these embodiments, the circuitry may be configured to receive the HARQ-ACK codebook comprising at least a first sub-codebook for HARQ feedbacks of the multiple CBG-based PDSCH transmissions bundled in spatial domain.

In some example embodiments, to receive the HARQ codebook, the circuitry may be configured to transmit a first indication for transmission of HARQ feedbacks bundled in time domain, transmit a second indication for transmission of HARQ feedbacks bundled in spatial domain, and receive the HARQ-ACK codebook comprising at least a second sub-codebook for HARQ feedbacks of the multiple TB-based PDSCH transmissions bundled in spatial domain.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device and from a network device, multiple code block group (CBG)-based Physical Downlink Shared Channel (PDSCH) transmissions scheduled by a first downlink control information (DCI), and at least one transport block (TB)-based PDSCH transmission; and
transmitting, to the network device, a HARQ-acknowledgement (HARQ-ACK) codebook comprising HARQ feedbacks of the multiple CBG-based PDSCH transmissions and the at least one TB-based PDSCH transmission.

2. The method of claim 1, wherein the HARQ-ACK codebook comprises:
a first sub-codebook for HARQ feedbacks of the multiple CBG-based PDSCH transmissions; and
a second sub-codebook for HARQ feedbacks of the at least one TB-based PDSCH transmission.

3. The method of claim 2, wherein the at least one TB-based PDSCH transmission comprises a TB-based PDSCH transmission scheduled by a second DCI and multiple TB-based PDSCH transmissions scheduled by a third DCI, the second sub-codebook comprises HARQ feedbacks of the TB-based PDSCH transmission and the multiple TB-based PDSCH transmissions, and the first sub-codebook follows the second sub-codebook.

4. The method of claim 2, wherein the at least one TB-based PDSCH transmission comprises a TB-based PDSCH transmission scheduled by a second DCI and multiple TB-based PDSCH transmissions scheduled by a third DCI, the second sub-codebook comprises a HARQ feedback of the TB-based PDSCH transmission, the HARQ codebook further comprises a third sub-codebook of HARQ feedbacks of the multiple TB-based PDSCH transmissions, the third sub-codebook immediately follows the second sub-codebook and the first sub-codebook follows the third sub-codebook.

5. (canceled)

6. The method of claim 2, further comprising:
receiving, from the network device, a CBG-based PDSCH transmission scheduled by a fourth DCI, and
wherein the HARQ-ACK codebook further comprises a fourth sub-codebook for CBG-based HARQ feedback of the CBG-based PDSCH transmission, the fourth sub-codebook follows the second sub-codebook, and the first sub-codebook immediately follows the fourth sub-codebook.

7. (canceled)

8. The method of claim 1, wherein the HARQ feedbacks of the multiple CBG-based PDSCH transmissions are bundled in time domain.

9-11. (canceled)

12. The method of claim 6, wherein a corresponding one of the first sub-codebook and the fourth sub-codebook further comprises a HARQ feedback for a group of less than M CBGs comprising at least one padding ACK bit.

13. The method of claim 6, wherein CBGs for the multiple CBG-based PDSCH transmissions are grouped into a first number of groups and a corresponding one of the first sub-codebook and the fourth sub-codebook comprises a first number of HARQ feedbacks of the first number of groups of CBGs.

14. (canceled)

15. The method of claim 2, further comprising:
receiving uplink DCI comprising a field for the first sub-codebook, and
wherein a payload size of the first sub-codebook is based on a maximum number of CBGs for a TB and a maximum number of transmissions schedulable by a single DCI.

16. The method of claim 2, wherein the uplink DCI further comprises a field for a fourth sub-codebook for a HARQ feedback of a single CBG-based PDSCH transmission scheduled by a fourth DCI, and a payload size of the fourth sub-codebook is based on a maximum number of CBGs for a TB schedulable by a single DCI.

17. The method of claim 1, wherein the at least one TB-based PDSCH transmission comprises a TB-based PDSCH transmission scheduled by a second DCI and multiple TB-based PDSCH transmissions scheduled by a third DCI, and wherein transmitting the HARQ-ACK codebook comprises:
in accordance with a determination that a maximum number of transmissions schedulable by a single DCI exceeds a scheduled number threshold, transmitting the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions; and
in accordance with a determination that a maximum number of transmissions schedulable by a single DCI is not exceeding the scheduled number threshold, transmitting the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

18. The method of claim 1, wherein the at least one TB-based PDSCH transmission comprises a TB-based PDSCH transmission scheduled by a second DCI and multiple TB-based PDSCH transmissions scheduled by a third DCI, and wherein transmitting the HARQ-ACK codebook comprises:
in accordance with a determination that a first value of a configuration parameter is received from the network device, transmitting the HARQ-ACK codebook comprising a first sub-codebook for HARQ feedbacks of the multiple CBG-based PDSCH transmissions, a second sub-codebook for a HARQ feedback of the TB-based PDSCH transmission, and a third sub-codebook for HARQ feedbacks of the multiple TB-based PDSCH transmissions; and
in accordance with a determination that a second value of a configuration parameter is received from the network device, transmitting the HARQ-ACK codebook comprising the first sub-codebook for HARQ feedbacks of the multiple CBG-based PDSCH transmissions and the second sub-codebook for HARQ feedbacks of the TB-based PDSCH transmission and the multiple TB-based PDSCH transmission.

19. The method of claim 2, wherein the second sub-codebook comprises HARQ-ACK bits for receipt of SPS data transmissions.

20. The method of claim 2, wherein HARQ-ACK bits for receipt of SPS data transmissions is behind the end of the second sub-codebook.

21. The method of claim 1, wherein the at least one TB-based PDSCH transmission comprises multiple TB-based PDSCH transmissions scheduled by a third DCI, and transmitting the HARQ codebook further comprises:
in accordance with a determination that a maximum number of transmissions schedulable by a single DCI is not exceeding a scheduled number threshold, transmitting the HARQ-ACK codebook comprising at least a second sub-codebook for HARQ feedbacks of the multiple TB-based PDSCH transmissions bundled in time domain; and
in accordance with a determination that the maximum number of transmissions schedulable by the single DCI exceeds the scheduled number threshold, transmitting the HARQ-ACK codebook comprising at least the second sub-codebook for HARQ feedbacks of the multiple TB-based PDSCH transmissions bundled in spatial domain.

22. The method of claim 1, wherein the at least one TB-based PDSCH transmission comprises multiple TB-based PDSCH transmissions scheduled by a third DCI, and transmitting the HARQ codebook further comprises:
in accordance with receipt of both a first indication for transmission of HARQ feedbacks bundled in time domain and a second indication for transmission of HARQ feedbacks bundled in spatial domain, transmitting the HARQ-ACK codebook comprising at least a second sub-codebook for HARQ feedbacks of the multiple TB-based PDSCH transmissions bundled in spatial domain.

23. The method of claim 1, wherein transmitting the HARQ codebook further comprises:
in accordance with a determination that a maximum number of transmissions schedulable by a single DCI is not exceeding a scheduled number threshold, transmitting the HARQ-ACK codebook comprising at least a first sub-codebook for HARQ feedbacks of the multiple CBG-based PDSCH transmissions bundled in time domain; and
in accordance with a determination that the maximum number of transmissions schedulable by the single DCI exceeds the scheduled number threshold, transmitting the HARQ-ACK codebook comprising at least a first sub-codebook for HARQ feedbacks of the multiple CBG-based PDSCH transmissions bundled in spatial domain.

24. The method of claim 1, wherein transmitting the HARQ codebook further comprises:
in accordance with receipt of both a first indication for transmission of HARQ feedbacks bundled in time domain and a second indication for transmission of HARQ feedbacks bundled in spatial domain, transmitting the HARQ-ACK codebook comprising at least a first sub-codebook for HARQ feedbacks of the multiple CBG-based PDSCH transmissions bundled in spatial domain.

25-46. (canceled)

47. A terminal device comprising:
a processor configured to:
receive, from a network device, multiple code block group (CBG)-based Physical Downlink Shared Channel (PDSCH) transmissions scheduled by a first downlink control information (DCI), and at least one transport block (TB)-based PDSCH transmission; and
transmit, to the network device, a HARQ-acknowledgement (HARQ-ACK) codebook comprising HARQ feedbacks of the multiple CBG-based PDSCH transmissions and the at least one TB-based PDSCH transmission.

48. A network device comprising:
a processor configured to:
transmit, to a terminal device, multiple code block group (CBG)-based Physical Downlink Shared Channel (PDSCH) transmissions scheduled by a first downlink control information (DCI), and at least one transport block (TB)-based PDSCH transmission; and
receive, from the terminal device, a HARQ-acknowledgement (HARQ-ACK) codebook comprising HARQ feedbacks of the multiple CBG-based PDSCH transmissions and the at least one TB-based PDSCH transmission.
